(19) United States
(12) Patent Application Publication
(10) Pub. No.: US 2004/0078339 A1
(43) Pub. Date: Apr. 22, 2004

(54) Priority based licensing

(76) Inventors: Christopher M. Goringe, New South Wales (AU); Peter D. Runcie, New South Wales (AU); Alan Vincent Green, New South Wales (AU); Alex M. Krumm-Heller, New South Wales (AU); Melanie Louise Smith, New South Wales (AU)

Correspondence Address: Bradley M. Knepper, SHERIDAN ROSS P.C., Suite 1200, 1560 Broadway, Denver, CO, 80202-5141, US

(21) Appl. No.: 10/278,504

(22) Filed: Oct. 22, 2002

(51) Int. Cl. G06F 17/60

(52) U.S. Cl. 705/59

(57) ABSTRACT

A priority based licensing system is provided. According to the invention, right to use licenses are allocated to users based on the priority rating of the users. Accordingly, licenses may be reallocated from low priority to high priority users when no unallocated licenses are available. The present invention allows organizations to efficiently utilize a limited number of licenses required in connection with the utilization of a resource.

### FIELD OF THE INVENTION

The present invention is directed to priority based licensing. In particular, the present invention is directed to insuring that high priority users have access to an availability limited resource, while permitting at least some access to the resource by lower priority users.

### BACKGROUND OF THE INVENTION

The use of software and other products is often controlled by license. For example, an organization typically must purchase a license for each copy of a software program, or for each user making use of a software program, at any particular instant in time. However, insuring that the organization holds enough licenses to permit access to all users who may require such access, while attempting to limit the total number of licenses held by the organization, has been problematic.

When purchasing licenses to allow users to concurrently access a resource, an organization will typically estimate or measure how many users in total are likely to use the product simultaneously and purchase that number of licenses. However, such an approach does not distinguish between high priority and low priority users. This can become problematic if the organization underestimates the number of concurrent user licenses required, and high priority or regular users are denied access because of use by low priority or casual users. Alternatively, an organization may simply purchase a user license for each regular and casual user. However, such an approach is inefficient, because all of the licenses held by the organization will rarely, if ever, be used at the same time.

In order to address some of the difficulties in determining a number of user licenses that an organization should hold, various approaches have been developed. For example, some resources may offer different licenses appropriate for different users. In particular, a different license pool may be established for each different class of user. Such an approach can insure that regular high priority users of a resource are guaranteed access, for example by establishing a pool of licenses for high priority users that contains a number of licenses equal to the number of such users. A license pool or pools for a lower priority users may contain a number of user licenses that is less than the total number of such users. However, such an approach is less efficient than having a single pool of shared licenses, as there usually will be unused licenses in each of the pools.

Another approach is transaction based licensing. According to a transaction based licensing scheme, the amount of use by an organization of a resource is monitored and is the basis for a license fee. However, such an approach entails high administrative overhead, and is not effective in governing access to a scarce resource.

Named user licensing is another approach. In a named user licensing scheme, each user is provided with a dedicated user license. However, an approach in which each potential user holds a license is inefficient, as there can be no sharing of user licenses between users.

### SUMMARY OF THE INVENTION

The present invention is directed to solving these and other problems and disadvantages of the prior art. According to the present invention, users of a resource are assigned a priority level. Allocation of the resource among users is made with reference to the priority levels. Accordingly, access to a resource by high priority users can be assured, even though a separate user license is not maintained for each potential user associated with the organization.

In accordance with an embodiment of the present invention, a first priority level is assigned to a first user, and a second priority level is assigned to a second user. In response to a request for a user license received from the first user, a license may be allocated to that user. With respect to a request for a license from the second user, an available license may be allocated to that user. If all licenses held by an organization with respect to the license pool are allocated, the priority of the first and second users maybe compared. If the second user's priority is higher than the first user's, the first user's license may be revoked. In accordance with an embodiment of the present invention, revocation of the first user's license includes notifying the first user that the license held by the first user will be revoked within a first period of time. The license may then be allocated to the second user after the first period of time has elapsed. In accordance with the further embodiment of the present invention, if the first user relinquishes the license prior to the first period of time elapsing, the license may be allocated to the second user immediately after it is relinquished by the first user.

In accordance with an embodiment of the present invention, a higher priority level is assigned to a regular user of a resource than is assigned to a casual user of a resource. In accordance with yet another embodiment of the present invention, a priority level assigned to a user is based, at least in part, on an amount of time that a requesting user has been waiting for access to the resource. In accordance with still another embodiment of the present invention, regular users of a resource may be assigned a high priority level, and casual users of the resource may be assigned a priority rating that is less than the priority rating assigned to regular users of the resource and that is based on an amount of time that a casual user has been waiting for access to a resource. In accordance with still another embodiment of the present invention, each user may be assigned a different priority rating, and that rating may be based on one or more factors, such as need for access to the resource or an amount of time that the requesting user has been waiting for access to that resource.

In accordance with an embodiment of the present invention, an apparatus is provided for controlling access to a resource. According to such an embodiment of the present invention, an input is provided for receiving information regarding a number of current users and for receiving requests for access to the resource. In addition, data storage is provided for storing a license allocation program. In addition, a processor capable of running the license allocation program is provided, the license allocation program functioning to allocate a right to access a resource to a first user having a first priority in favor of the second user having a second priority, and to reallocate the right to access from the second user to the first user. The apparatus may further comprise a plurality of client computers and a communication channel interconnecting the plurality of computers to the processor. A user may be associated with each client computer.

These and other advantages and features of the invention will become apparent from the following description of the invention taken together with the drawing.

### BRIEF DESCRIPTION OF THE DRAWINGS

FIG. 1A depicts a license allocation scheme in accordance with the prior art;

FIG. 1B depicts another license allocation scheme in accordance what the prior art;

FIG. 1C depicts yet another license allocation scheme in accordance with the prior art;

FIG. 2A depicts a request for access to a resource in accordance with an embodiment of the present invention;

FIG. 2B depicts the allocation of licenses following the request depicted in FIG. 2A;

FIG. 3 is a block diagram depicting a system implementing a priority based licensing system in accordance with an embodiment of the present invention; and

FIG. 4 is a flow chart depicting the operation of a priority based licensing system in accordance an embodiment of the present invention.

### DETAILED DESCRIPTION

The present invention is directed to priority based licensing.

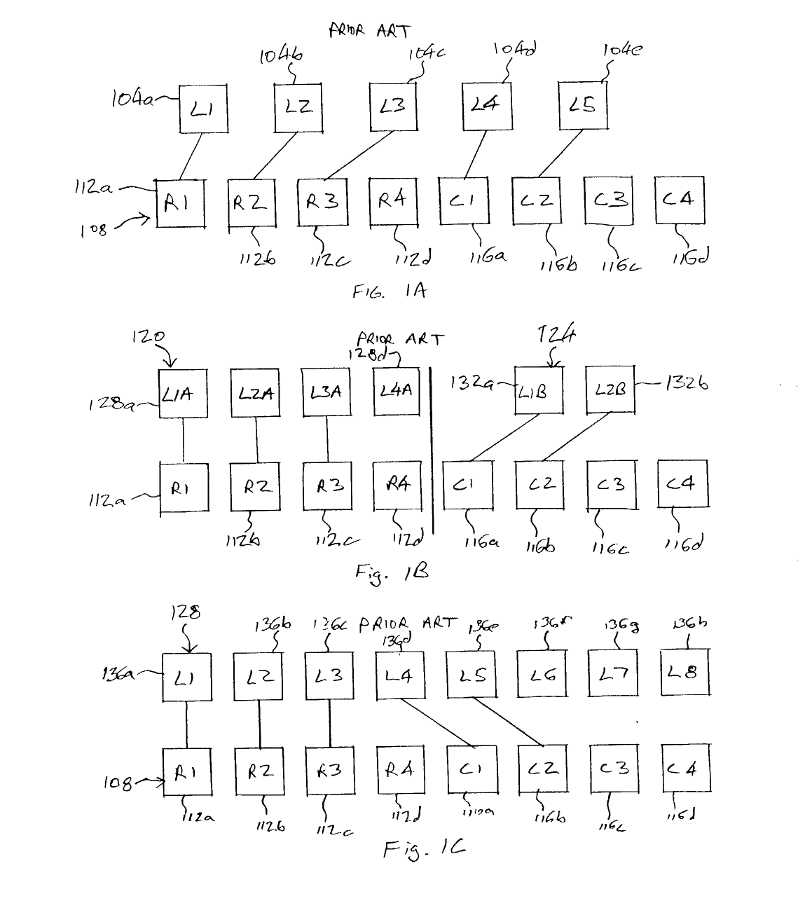

FIG. 1A depicts a licensing scheme in accordance the prior art. As shown in FIG. 1A, an organization may hold a fixed number of licenses 104. Each of the licenses 104 may be allocated to users 108. The users 108 may include regular users 112 and casual users 116. As depicted in FIG. 1A, there are fewer licenses 104 then potential users 108. Furthermore, as also shown in FIG. 1A, regular users 112 may be unable to access a resource (i.e., may be unable to obtain a license 104) where casual users 116 have been allocated licenses 104. Furthermore, a regular user 112 may be prevented from accessing a resource even if the number of licenses 104 is greater than the number of regular users 108, if casual users 116 are permitted to use the licenses 104. Accordingly, a prior art licensing scheme such as shown in FIG. 1A does not guarantee that a regular user 112 can access a resource.

Another prior art approach to allocating licenses among users is depicted in FIG. 1B. In FIG. 1B, there are first 120 and second 124 license pools. The first license pool 120 contains licenses 128 that maybe accessed by regular users 112, but not by casual users 116. The second license pool 124 contains licenses 132 that can be accessed by casual users 116 but not by regular users 112. Where, as shown in FIG. 1B, the number of licenses 128 reserved for use by regular users 112 is equal to the potential number of regular users 112, regular users 112 are assured access to a license 128. Casual users 116 may compete for licenses 132 included in the second pool 124. Furthermore, because casual users 116 typically have less need for access to the resource, the number of licenses 132 per casual user 116 may be less than the number of licenses 128 per regular user 112, while providing reasonable access to casual users 116. However, the provision of two separate license pools 120, 124 is inefficient. For example, as shown in FIG. 1B, a regular user R4 112d may be engaged in activities not involving the licensed resource, and may therefore not utilize an available license 128d. At the same time, each of the licenses 132 provided as part of the second license pool 124 may be allocated to casual users C1 116a and C2 116b, leaving no licenses available for casual users C3 116c or C4 116d.

Still another prior art approach to providing licenses to users of the licensed resources is depicted in FIG. 1C. In FIG. 1C, a license pool 128 having a number of licenses 136 equal to the total number of potential users 108 is shown. Although such an arrangement insures that a license 136 is always available to a user 108, it is inefficient where all of the potential users 108 are not utilizing the licensed resource.

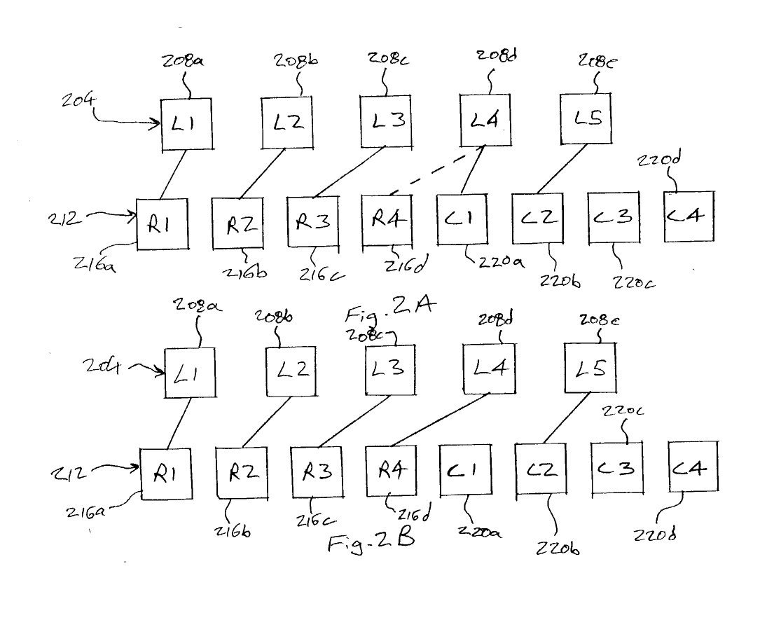

With reference now to FIGS. 2A and 2B, a licensing scheme in accordance with an embodiment of the present invention is illustrated. As shown in FIGS. 2A and 2B, a license pool 204 containing a number of licenses 208 is provided. As used herein, the term “license” refers to a right to access and use a resource. Furthermore, the term “license” includes, but is not limited to, a contractual agreement that permits access to a resource. For example, a “license” as used herein may include the allocation of a right to access a resource that is issued on the basis of the load (e.g., the number of current users or the number of transactions pending) on the resource, rather on the basis of a legal consideration. The term “resource” may include a computer program, a database, a computer, a computer processor, memory, or any other scarce or valuable resource.

The number of licenses 208 included in the license pool 204 is less than the total number of potential users 212. In addition, in accordance with an embodiment of the present invention, a number of licenses 208 included in the license pool 204 is equal to or greater than the number of regular users 216 included in the total number of users 212. However, depending on the particular requirements of the organization implementing the licensing scheme, the number of licenses 208 available in the license pool 204 may be less than the number of regular users 216. As used herein, the term “users” includes human users, either directly or through a computing device, or a computing resource, such as a computer program.

In FIGS. 2A and 2B, the allocation of a license 204 to a user 212 is depicted by a solid line. A dotted line, such as shown interconnecting regular user R4 216d to license for 208d depicts a request for a license by a user. In particular, in FIG. 2A, regular user R4 216d has requested access to a license that, at the time shown in FIG. 2A, is allocated to casual user C1 220A. In FIG. 2B, the license L4 208d is shown allocated to regular user R4 216d. That is, FIG. 2B depicts the reallocation of license L4 208d to the regular user R4 216d from the casual user C1 220a. Accordingly, it can be appreciated that a priority based licensing scheme in accordance with an embodiment of the present invention allows a user with a relatively high priority (e.g., regular user R4 216d) to take a license from a user having a lower priority (e.g., casual user C1 220a).

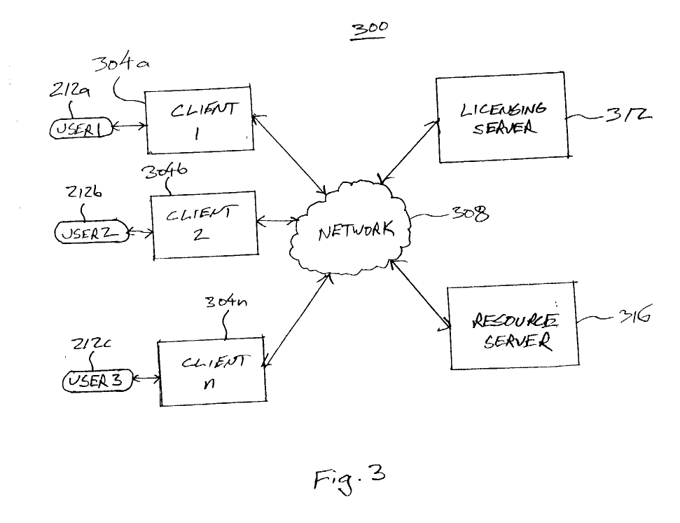

With reference now to FIG. 3, a system 300 in accordance with an embodiment of the present invention is depicted. In general, the system 300 includes a plurality of client devices or computers 304 interconnected to a network 308. The client computers 304 are generally each associated with a user 212. For example, each client computer 304 may comprise a user work station. The network 308 may include any communication or data network suitable for interconnecting communication or computing devices. For example, the network 308 may comprise one or more computer networks, including the Internet.

The system 300 may also include a licensing server 312. In general, the licensing server 312 functions to allocate licenses 204 among the client computers 304 (and thus among associated users 212). Accordingly, the licensing server 312 may comprise a general purpose computer or server running suitable programming that is in communication with the client computers 304 across the network 308.

The system 300 may additionally include a resource server 316. In general, a provided resource server 316 comprises a general purpose or server computer containing a resource, such as a database or computer program, the use of which is governed by user licenses 204. In general, access to the resources maintained on the resource service 316 by the client computers 304 may be through the network 308.

As can be appreciated by one of skill in the art, the various components depicted in the system 300 may be combined. In addition, not all of the various components depicted in FIG. 3 need be provided. For example, the resource to which access is governed by licenses may be distributed among a number of devices, including among the client computers 304. In addition, the functions of the licensing server 312 may be distributed, for example among the client computers 304.

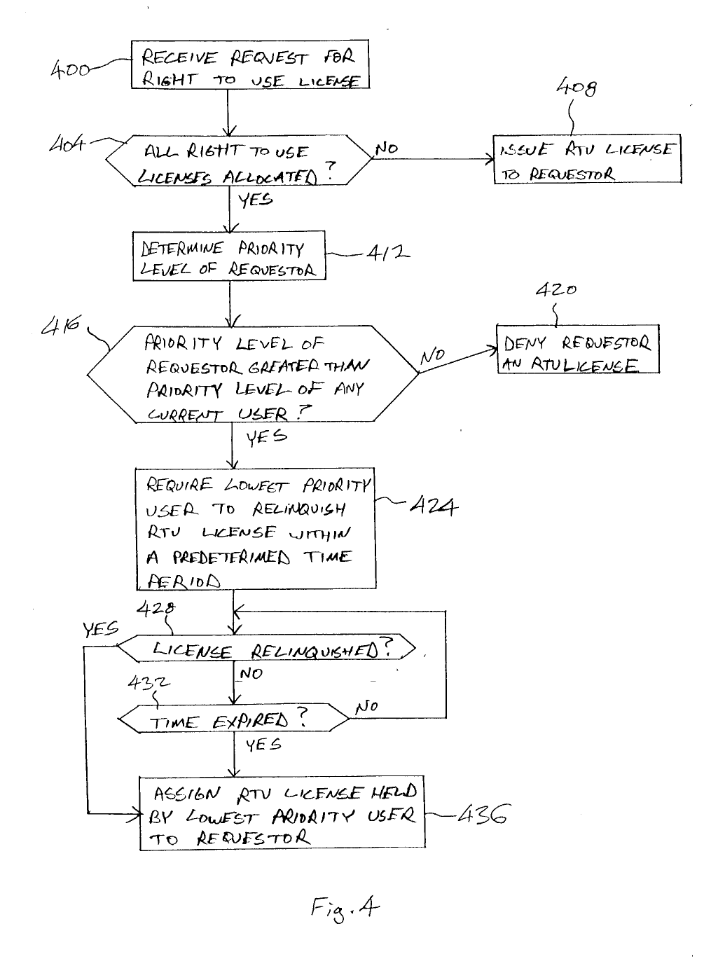

With reference now to FIG. 4, the operation of a system 300 in accordance with an embodiment of the present invention is depicted. Initially, at step 400, a request for a right to use license 208 is received from a user 212. At step 404, a determination is made as to whether all right to use licenses 208 in the pool 204 have already been allocated to users 212. If a right to use license 208 is available, such license is issued or allocated to the requesting user 212 (step 408).

If all licenses 208 have been allocated, the priority level of the requesting user 212 is determined (step 412). Next, the priority level of the requesting user 212 with respect to users 212 who have been allocated a license 204 is determined. In particular, a determination is made as to whether the priority level of the requesting user 212 is greater than the priority level of any current user 212 (step 416). If the priority level of the requesting user 212 is not greater than any current user 212 of a license 208, the requesting user 212 is denied a right to use license (step 420). For example, if all licenses 208 in a pool 204 have been allocated to regular users 216, and the requester is a casual user 220, the requesting user 212 is denied access.

If the priority level of the requesting user 212 is greater than the priority level of a user 212 that has been allocated a license 208, the lowest priority user 212 holding a license is required to relinquish the right to use license 208 within a predetermined period of time (step 424). For example, as depicted in FIG. 2A, the request made by the regular user R4 216d for a license results in the license L4 208d that had been allocated to casual user C1 220a being reallocated to the regular user R4 216d, leaving the casual user C1 220a without access to a license 208 (see FIG. 2B), where casual user C1 220a has a lower priority level through casual user C2 220b.

The step 424 of requiring a user 212 to relinquish a license 208 may include notifying the user 212 that the license 208 is being reassigned to a higher priority user 212 within the predetermined time period. The user 212 may then be allowed to make an orderly exit from the resource before the license 208 is reallocated. For example, in accordance with an embodiment of the present invention, a two minute time period is provided to allow a user 212 to relinquish the license 208. Of course, the particular period of time allowed for a user 212 to relinquish a license 208 may be varied according to the particular requirements of the users 212 or the resource being licensed. At step 428, a determination is made as to whether the license 208 that is being reassigned has been relinquished. In general, even though a predetermined time period is allowed for a user 212 to relinquish a license 208, it is expected that the user 212 will usually relinquish the license 208 prior to the expiration of that time period. If the license 208 has not yet been relinquished, a determination is made as to whether the time period has expired (step 432). If the time period has not yet expired, the system returns to step 428.

After either the user 212 whose license 208 is being reallocated has relinquished license 208, or the predetermined time period has expired, the right to use license 208 is assigned to the requesting user 212 (step 436). For example, with reference again to FIGS. 2A and 2B, the license L4 208d held by casual user C1 220a is assigned to regular user R4 216D.

Although the description above has provided an example of the reallocation of a right to use license 208 from a casual user 220 to a regular user 216, it can be appreciated that additional priority levels may be assigned. For example, according to an embodiment of the present invention, the license L4 208d held by casual user C1 220a in the example of FIGS. 2A and 2B may be required to relinquish the license L4 208d because casual user C1 220a has a lower priority level than both the requesting user (regular user R4 216d) and casual user C2 220b. The relative priority between casual user C1 220a and C2 220b may be determined by any selected criterion. For example, the need for access to the resource subject to licensing, as determined by, for example, the relevance of the resource to the regular duties of the user 212, may be used to determine the relative priority of users 212. In addition or alternatively, the amount of time that a user has held a license 208 may be a criterion for priority level. For instance, the casual user C1 220a may have held a license 208 for a longer period of time than casual user C2 220b, and thus casual user C1 220a may be required to relinquish the license in preference to casual user C2 220b in response to the request by the higher priority user (i.e., regular user R4 216d).

As can also be appreciated, there need not be separate classes of users 212 in order to take advantage of the priority based licensing system of the present invention. For example, each user 212 may be provided with an individual priority rating. The priority rating afforded a user 212 may be based on a determination of the user's 212 need for access to the resource that is licensed, the amount of time that the user 212 has been waiting for access to the resource, and the position of the user 212 within the organization.

The foregoing discussion of the invention has been presented for purposes of illustration and description. Further, the description is not intended to limit the invention to the form disclosed herein. Consequently, variations and modifications commensurate with the above teachings, within the skill and knowledge of the relevant art, are within the scope of the present invention. The embodiments described hereinabove are further intended to explain the best mode presently known of practicing the invention and to enable others skilled in the art to utilize the invention in such or in other embodiments and with various modifications required by their particular application or use of the invention. It is intended that the appended claims be construed to included the alternative embodiments to the extent permitted by the prior art.

What is claimed is:

1. A method for maximizing the use of a license pool, comprising:
receiving a request for a user license from a first user;
receiving a request for a user license from a second user;
assigning at least a first priority level to said first user;
assigning at least a second priority level to said second user; and
in response to said second request, at least one of allocating an available user license to said first user, allocating an available user license to said second user, and comparing said first priority level to said second priority level.

2. The method of claim 1, further comprising:
obtaining a first plurality of user licenses

3. The method of claim 1, wherein a first user license is allocated to said first user, wherein no user licenses are available when said request for a user license is received from said second user, and wherein said first priority level is less than said second priority level, said method further comprising:
revoking said first license allocated to said first user.

4. The method of claim 3, wherein said step of revoking comprises:
notifying said first user that said first user license will be revoked within a first period of time; and
allocating said first user license to said second user after said first period of time has elapsed.

5. The method of claim 3, wherein said step of revoking comprises:
notifying said first user that said first user license will be revoked;
receiving an indication that said first user has released said first user license; and
allocating said first user license to said second user.

6. The method of claim 1, wherein a first user license is allocated to said first user and a said second user license is allocated to said second user, said method further comprising:
receiving a request for a user license from a third user;
assigning a third priority level to said third user; and
in response to said third request, at least one of allocating an available user license to said third user, and comparing said first and second priority levels to said third priority level.

7. The method of claim 1, wherein a first user license is allocated to said first user and a second license is allocated to said second user, said method further comprising:
receiving a third request for a user license from a third user;
assigning a third priority to said third user;
comparing said first and second priority levels; and
in response to said third level having a higher priority than at least one of said first and second priority levels, reallocating a user license from a user associated with said at least one of said first and second priority levels to said third user.

8. The method of claim 7, wherein said first user license is reallocated from said first user to said third user, wherein said first user is a casual user, and wherein said third user is a regular user.

9. The method of claim 8, wherein said second user is a regular user.

10. The method of claim 8, wherein said second user is a casual user, and wherein said first user has had a user license for a first period of time and said second user has had a user license for a second period of time.

11. The method of claim 1, wherein said first priority level is higher than said second priority level, and wherein said first user is associated with a first wait time and said second user is associated with a second wait time.

12. The method of claim 1, wherein in response to said second request said step of comparing said first priority level to said second priority level is performed.

13. The method of claim 1, wherein in response to said second request said step of allocating an available license to said second user is performed.

14. The method of claim 1, wherein in response to said second request said step of allocating an available license to said first user is performed.

15. A logic circuit operable to perform the steps of claim 1.

16. A computational component for performing a method, the method comprising:
receiving a first plurality of requests for user licenses from each of a first plurality of users;
assigning each of said first plurality of users a priority level, wherein each of said active users may have a different assigned priority level;
allocating all user licenses included in a first plurality of user licenses to at least a first portion of said first plurality of users, whereby said users allocated said first plurality of user licenses become active users;
receiving a request for a user license from a first requesting user;
assigning a priority level to said first requesting user;
comparing said priority level assigned to said first requesting user to said priority level assigned to at least one of said active users; and
in response to said priority level assigned to said first requesting user being greater than said at least one of said active users, reallocating a first user license from said at least one of said active users to said first requesting user.

17. The method of claim 16, wherein said step of reallocating comprises:
notifying said at least one of said active users that said first user license is being reallocated to said second user; and
allocating said first user license to said second user.

18. The method of claim 16, wherein said step of reallocating comprises:
notifying said at least one of said active users that said first user license will be reallocated to said second user in a first period of time; and
reallocating said first user license to said second user after said first period of time has elapsed.

19. The method of claim 16, wherein said step of reallocating comprises:
issuing a request to said at least one of said active users to relinquish said first user license; and
in response to said at least one of said active users relinquishing said first user license, allocating said user license to said second user.

20. The method of claim 16, wherein said first portion of said first plurality of users includes less than all of said first plurality of users, and wherein at least a second portion of said first plurality of users are not allocated a user license.

21. The method of claim 20, further comprising:
receiving a request for a user license from a first user included in said second portion of said first plurality of users; and
assigning a new priority level to said request, wherein said priority level is different from a priority level assigned to a previous request for a user license received from said first user included in said second portion of said second plurality of users.

22. The method of claim 16, wherein a casual user of a resource associated with said first plurality of user licenses is assigned a relatively low priority level, and wherein a regular user of said resource associated with said first plurality of user licenses is assigned a relatively high priority level.

23. The method of claim 16, further comprising:
allocating user licenses included in a second plurality of user licenses to users, wherein a user having a first priority level is assigned a user license from one of said first plurality of user licenses and said second plurality of user licenses, and wherein a user having a second priority level is assigned a license from said second plurality of user licenses.

24. The method of claim 16, further comprising:
allocating user licenses included in a second plurality of user licenses to users, wherein a user having a first priority level is assigned a user license from said first plurality of user licenses, and wherein a user having a second priority level is assigned a license from said second plurality of user licenses.

25. The method of claim 16, wherein said step of assigning priority levels comprises:
determining a time of receipt of said request from each of said users, wherein a user making an earlier request is assigned a higher priority level than a user making a later request.

26. The method of claim 16, wherein said computational component comprises a computer readable storage medium carrying instructions for performing the method.

27. An apparatus for allowing access to a resource, comprising:
an input, wherein information regarding a number of current users and regarding a request for access to said resource is received;
a license allocation agent operative to allocate a right to access a resource to a first user having a first priority in favor of a second user having a second priority, wherein said right to access held by said second user is reallocated to said first user.

28. The apparatus of claim 27, further comprising:
a plurality of client computers; and
a communication channel interconnecting said plurality of client computers to said agent, wherein a user is associated with each of at least a first number of said plurality of client computers.

29. The apparatus of claim 27, wherein said resource comprises a computer resource.

30. The apparatus of claim 29, wherein said computer resource comprises a computer program.

31. The apparatus of claim 27, wherein said license allocation agent comprises data storage and programming stored thereon.

32. The apparatus of claim 31, wherein said data storage comprises a logic circuit and wherein said programming is encoded in said logic circuit.

33. The apparatus of claim 27, wherein said license allocation agent comprises a processor running license allocation software.

34. An apparatus for allocating access to a resource, comprising:
means for assigning one of at least a first and second priority level to a first plurality of users;
means for comparing a priority level of a first user to a priority level of a second user;
means allocating access to a said resource to a second plurality of users, wherein all of said second plurality of users belong to said first plurality of users; and
means for reallocating access to said resource from a one of said second plurality of users to a one of said first plurality of users requesting access, wherein a priority level of said one of said second plurality of users is lower than a priority level of said one of said first plurality of users requesting access.

35. The apparatus of claim 34, further comprising:
means for notifying a user that access to said resource is being reallocated.
